(19) United States
(12) Patent Application Publication
(10) Pub. No.: US 2022/0013820 A1
(43) Pub. Date: Jan. 13, 2022

(54) BATTERY RECYCLING WITH ELECTROLYSIS OF THE LEACH TO REMOVE COPPER IMPURITIES

(71) Applicant: BASF SE, Ludwigshafen (DE)

(72) Inventors: Wolfgang ROHDE, Ludwigshafen (DE); Domnik BAYER, Ludwigshafen (DE); Torben ADERMANN, Ludwigshafen (DE)

(73) Assignee: BASF SE, Ludwigshafen (DE)

(21) Appl. No.: 17/309,010

(22) PCT Filed: Oct. 8, 2019
(86) PCT No.: PCT/EP2019/077258

§ 371 Date: Apr. 13, 2021

(30) Foreign Application Priority Data
Oct. 15, 2018 (EP) 18200335.0

(51) Int. Cl. H01M 10/54; C25C 1/12; C22B 3/00; C22B 7/00; C25C 1/08

(52) U.S. Cl. CPC H01M 10/54; C25C 1/12; C25C 1/08; C22B 7/007; C22B 23/043

(57) ABSTRACT

The present disclosure relates to a process for the recovery of transition metals from batteries comprising treating a transition metal material with a leaching agent to yield a leach which contains dissolved copper impurities, and depositing the dissolved copper impurities as elemental copper on a particulate deposition cathode by electrolysis of an electrolyte containing the leach.

The present invention relates to a process for the recovery of transition metals from batteries comprising treating a transition metal material with a leaching agent to yield a leach which contains dissolved copper impurities, and depositing the dissolved copper impurities as elemental copper on a particulate deposition cathode by electrolysis of an electrolyte containing the leach. Combinations of preferred embodiments with other preferred embodiments are within the scope of the present invention.

Lifetime of batteries, especialy lithium ion batteries, is not unlimited. It is to be expected, therefore, that a growing number of spent batteries will emerge. Since they contain important transition metals such as, but not limited to cobalt and nickel, and, in addition, lithium, spent batteries may form a valuable source of raw materials for a new generation of batteries. For that reason, increased research work has been performed with the goal of recycling transition metals—and, optionally, even lithium—from used lithium ion batteries.

Various processes have been found to raw material recovery. One process is based upon smelting of the corresponding battery scrap followed by hydrometallurgical processing of the metallic alloy (matte) obtained from the smelting process. Another process is the direct hydrometallurgical processing of battery scrap materials. Such hydrometallurgical processes will furnish transition metals as aqueous solutions or in precipitated form, for example as hydroxides, separately or already in the desired stoichiometries for making a new cathode active material.

U.S. Pat. No. 6,514,311 B1 discloses a process of recovering metals from waste batteries including an electrolysis step with a stainless steel screen cathode.

Various objects were pursued by the process of the present invention:
An easy, cheap, and/or efficient recovery of the transition metals, such as nickel and if present cobalt and manganese.
The recovery of further valuable elements, such as lithium and carbon (e.g. graphite particles).
A recovery of the transition metals or of further valuable elements in high purity, especially with low contents of copper and/or noble metals like Ag, Au and platinum group metals.
Avoid that new impurities are introduced into the process that would require an additional purification step.
A fast process, especially the electrolysis should be fast and efficient.
A high selectivity for removing copper impurities.

A low amount of copper is especially important in cases where the transition metal compounds recovered from battery scrap will be used for the production of fresh cathode active materials for lithium ion batteries, as such impurities may form conductive dendrites in the battery cell which will cause short-cuts and destruction of the cells or even the battery.

The object was solved by a a process for the recovery of transition metals from batteries comprising

(a) treating a transition metal material with a leaching agent to yield a leach which contains dissolved copper impurities, and

(b) depositing the dissolved copper impurities as elemental copper on a particulate deposition cathode by electrolysis of an electrolyte containing the leach.

Recovery of transition metals from batteries, such as lithium ion batteries, usually means that the transition metals (e.g. nickel, cobalt and/or manganese) and optionally further valuable elements (e.g. lithium and/or carbon) can be at least partly recovered, typically at a recovery rate of each at least 10, 20, 30, 40, 50, 60, 70, 80, 90, or 95 wt %. Preferably, at least nickel, cobalt and/or lithium is recovered by the process.

The transition metals and optionally further valuable elements are recovered from batteries, preferably lithium ion batteries, such as used or new batteries, parts of batteries, off-spec materials thereof (e.g. that do not meet the specifications and requirements), or production waste from battery production.

The transition metal material is usually a material that stems from the batteries, preferably the lithium ion batteries. For safety reasons, such batteries are discharged completely, otherwise, shortcuts may occur that constitute fire and explosion hazards. Such lithium ion batteries may be disassembled, punched, milled, for example in a hammer mill, or shredded, for example in an industrial shredder. From this kind of mechanical processing the active material of the battery electrodes may be obtained containing a transition metal material which may have a regular shape, but usually it has irregular shape. It is preferred, though, to remove a light fraction such as housing parts made from organic plastics and aluminum foil or copper foil as far as possible, for example in a forced stream of gas, air separation or classification. The transition metal material may also be obtained as metal alloy from smelting battery scrap. Preferably, the transition metal material is obtained from lithium ion batteries and contains lithium.

The transition metal material is often from battery scraps of batteries, such as lithium ion batteries. Such battery scraps may stem from used batteries or from production waste, for example off-spec material. In a preferred form the transition metal material is obtained from mechanically treated battery scraps, for example from battery scraps treated in a hammer mill or in an industrial shredder. Such transition metal material may have an average particle diameter (D50) in the range of from 1 μm to 1 cm, preferably from 1 to 500 μm, and in particular from 3 to 250 μm. Bigger parts of the battery scrap like the housings, the wiring and the electrode carrier films are usually separated mechanically such that the corresponding materials can be widely excluded from the transition metal material that is employed in the process. The mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1 to 99% by weight of water.

The mechanically treated battery scrap may be subjected to a heat treatment in a wide range of temperatures under different atmospheres. The temperature range is usually in the range of 100 to 900° C. Lower temperatures below 300° C. serve to evaporate residual solvents from the battery electrolyte, at higher temperatures the binder polymers may decompose while at temperatures above 400° C. the composition of the inorganic materials may change as some transition metal oxides may become reduced either by the carbon contained in the scarp material or by introducing reductive gases. By such a heat treatment the morphology of the transition metal material is usually retained, only the chemical composition may be altered. However, such heat treatment is fundamentally different from a smelting process where molten transition metal alloys and molten slags are formed. After such a heat treatment the material obtained may be leached with water or weak or diluted acids in order to dissolve selectively easy soluble constituents especially salts of lithium that may have been formed during the heat treatment e.g. lithium carbonate and lithium hydroxide. In one form the transition metal material is obtained from mechanical processing of battery scrap that has been heat treated (e.g. at 100 to 900° C.) and optionally under a hydrogen atmosphere.

Preferably, the transition metal material is obtained from mechanically treated battery scraps, or it is obtained as metal alloy from smelting battery scrap.

The transition metal material may contain lithium and its compounds, carbon in electrically conductive form (for example graphite, soot, and graphene), solvents used in electrolytes (for example organic carbonates such diethyl carbonate), aluminum and compounds of aluminum (for example alumina), iron and iron compounds, zinc and zinc compounds, silicon and silicon compounds (for example silica and oxidized silicon SiO_{y} with zero<y<2), tin, silicon-tin alloys, and organic polymers (such as polyethylene, polypropylene, and fluorinated polymers, for example polyvinylidene fluoride), fluoride, compounds of phosphorous (that may stem from liquid electrolytes, for example in the widely employed LiPF₆ and products stemming from the hydrolysis of LiPF₆).

The transition metal material may contain 1-30 wt %, preferably 3-25 wt %, and in particular 8-16 wt % nickel, as metal or in form of one or more of its compounds.

The transition metal material may contain 1-30 wt %, preferably 3-25 wt %, and in particular 8-16 wt % cobalt, as metal or in form of one or more of its compounds.

The transition metal material may contain 1-30 wt %, preferably 3-25 wt %, and in particular 8-16 wt % manganese, as metal or in form of one or more of its compounds

The transition metal material may contain 0.5-45 wt %, preferably 1-30 wt %, and in particular 2-12 wt % lithium, as metal or in form of one or more of its compounds

The transition metal material may contain 100 ppm to 15% by weight of aluminum, as metal or in form of one or more of its compounds.

The transition metal material may contain 20 ppm to 3% by weight of copper, as metal or in form of one or more of its compounds.

The transition metal material may contain 100 ppm to 5% by weight of iron, as metal or alloy or in form of one or more of its compounds. The transition metal material may contain 20 ppm to 2% by weight of zinc, as metal or alloy or in form of one or more of its compounds. The transition metal material may contain 20 ppm to 2% by weight of zirconium, as metal or alloy or in form of one or more of its compounds. The transition metal material may contain 20 ppm to 2% by weight of tungsten, as metal or alloy or in form of one or more of its compounds. The transition metal oxide material may contain 0.5% to 10% by weight of fluorine, calculated as a sum of organic fluoride bound in polymers and inorganic fluoride in one or more of its inorganic fluorides. The transition metal material may contain 0.2% to 10% by weight of phosphorus. Phosphorus may occur in one or more inorganic compounds.

The transition metal material usually contains nickel and at least one of cobalt and manganese. Examples of such transition metal materials may be based on LiNiO₂, on lithiated nickel cobalt manganese oxide (“NCM”) or on lithiated nickel cobalt aluminum oxide (“NCA”) or mixtures thereof.

Examples of layered nickel-cobalt-manganese oxides are compounds of the general formula Li₁₊ₓ(NiₐCo_{b}Mn_{c}M¹_{d})₁₋ₓO₂ with M¹ being selected from Mg, Ca, Ba, Al, Ti, Zr, Zn, Mo, V and Fe, the further variables being defined as follows: zero≤x≤0.2, 0.1≤a≤0.8, Zero≤b≤0.5, preferably 0.05<b≤0.5, zero≤c≤0.6, zero≤d≤0.1, and a+b+c+d=1. Preferred layered nickel-cobalt-manganese oxides are those where M¹ is selected from Ca, Mg, Zr, Al and Ba, and the further variables are defined as above. Preferred layered nickel-cobalt-manganese oxides are Li₍₁₊ₓ)[Ni_{0.33}Co_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}Co_{0.2}Mn_{0.2}]₍₁₋ₓ₎O₂, Li₍₁₊ₓ₎[Ni_{0.7}Co_{0.2}Mn_{0.3}]₍₁₋ₓ₎O₂, and Li₍₁₊ₓ₎[Ni_{0.8}Co_{0.1}Mn_{0.1}]₍₁₋ₓ₎O₂, each with x as defined above.

Examples of lithiated nickel-cobalt aluminum oxides are compounds of the general formula Li[NiₕCoᵢAlⱼ]O₂₊ᵣ, where h is in the range of from 0.8 to 0.90, i is in the range of from 0.15 to 0.19, j is in the range of from 0.01 to 0.05, and r is in the range of from zero to 0.4.

### Prior Step (a)

Optionally, the transition metal material can be treated prior step (a) by various methods.

It is possible to at least partially remove used electrolytes before step (a), especially used electrolytes that comprise an organic solvent or a mixture of organic solvents, for example by mechanic removal or drying, for example at temperatures in the range of from 50 to 300° C. A preferred range of pressure for the removal of organic solvent(s) is 0.01 to 2 bar, preferably 10 to 100 mbar.

Before step (a) it is preferred to wash the transition metal material with water and to thereby remove liquid impurities and water-soluble impurities from the transition metal material. Said washing step may be improved by a grinding for example in a ball mill or stirred ball mill. The washed transition metal material may be recovered by a solid-liquid separation step, for example a filtration or centrifugation or any kind of sedimentation and decantation. In order to support the recovery of finer particles of such solid transition metal material, flocculants may be added, for example polyacrylates.

Before step (a) at least one solid-solid separation step can be made, for example for the at least partial removal of carbon and/or polymeric materials. Examples of solid-solid separation steps are classification, gravity concentration, flotation, dense media separation or magnetic separation. Usually an aqueous slurry obtained prior to step (a) may be subjected to the solid-solid separation. The solid-solid separation step often serves to separate hydrophobic non-soluble components like carbon and polymers from the metal or metal oxide components.

The solid-solid separation step may be performed by mechanical, column or pneumatic or hybrid flotations. Collector compounds may be added to the slurry which render the hydrophobic components even more hydrophobic. Suitable collector compounds for carbon and polymeric materials are hydrocarbons or fatty alcohols which are introduced in amounts of 1 g/t to 50 kg/t of transition metal material.

It is also possible to perform the flotation in an inverse sense, i.e., transforming the originally hydrophilic components into strongly hydrophobic components by special collector substances, e.g., fatty alcohol sulfates or esterquats. Preferred is the direct flotation employing hydrocarbon collectors. In order to improve the selectivity of the flotation towards carbon and polymeric material particles suppressing agents can be added that reduce the amounts of entrained metallic and metal oxide components in the froth phase. Suppressing agents that can be used may be acids or bases for controlling the pH value in a range of from 3 to 9 or ionic components that may adsorb on more hydrophilic components. In order to increase the efficiency of the flotation it may be advantageous to add carrier particles that form agglomerates with the hydrophobic target particles under the flotation conditions.

Magnetic or magnetizable metal or metal oxide components may be separated by magnetic separation employing low, medium or high intensity magnetic separators depending on the susceptibility of the magnetizable components. It is possible as well to add magnetic carrier particles. Such magnetic carrier particles are able to form agglomerates with the target particles. By this also non-magnetic materials can be removed by magnetic separation techniques. preferably, magnetic carrier particles can be recycled within the separation process.

By the solid-solid separation steps typically at least two fractions of solid materials present as slurries will be obtained: One containing mainly the transition metal material and one containing mainly the carbonaceous and polymeric battery components. The first fraction may be then fed into step (a) of the present invention while the second fraction may be further treated in order to recover the different constituents i.e. the carbonaceous and polymeric material.

### Step (a)

Step (a) includes treating the transition metal material with the leaching agent to yield a leach which contains the dissolved copper impurities.

In the course of step (a), the transition metal material is treated with a leaching agent, which is preferably an acid selected from sulfuric acid, hydrochloric acid, nitric acid, methanesulfonic acid, oxalic acid and citric acid or a combination of at least two of the foregoing, for example a combination of nitric acid and hydrochloric acid. In another preferred form the leaching agent is an
inorganic acid such as sulfuric acid, hydrochloric acid, nitric acid,
an organic acid such as methanesulfonic acid, oxalic acid, citric acid, aspartic acid, malic acid, ascorbic acid, or glycine,
a base, such as ammonium or
a complex former, such as chelates like EDTA.

Preferably, the leaching agent is an aqueous acid, such as an inorganic or organic aqueous acid. The concentration of acid may be varied in a wide range, for example of 0.1 to 98% by weight and preferably in a range between 10 and 80%. Preferred example of aqueous acids is aqueous sulfuric acid, for example with a concentration in the range of from 10 to 98% by weight. Preferably, aqueous acid has a pH value in the range of from −1 to 2. The amount of acid is adjusted to maintain an excess of acid referring to the transition metal. Preferably, at the end of step (a) the pH value of the resulting solution is in the range of from −0.5 to 2.5.

The treatment in accordance with step (a) may be performed at a temperature in the range of from 20 to 130° C. If temperatures above 100° C. are desired, step (a) is carried out at a pressure above 1 bar. Otherwise, normal pressure is preferred. In the context of the present invention, normal pressure means 1 bar.

In one form step (a) is carried out in a vessel that is protected against strong acids, for example molybdenum and copper rich steel alloys, nickel-based alloys, duplex stainless steel or glass-lined or enamel or titanium coated steel. Further examples are polymer liners and polymer vessels from acid-resistant polymers, for example polyethylene such as HDPE and UHMPE, fluorinated polyethylene, perfluoroalkoxy alkanes (“PFA”), polytetrafluoroethylene (“PTFE”), PVdF and FEP. FEP stands for fluorinated ethylene propylene polymer, a copolymer from tetrafluoroethylene and hexafluoropropylene.

The slurry obtained from step (a) may be stirred, agitated, or subjected to a grinding treatment, for example in a ball mill or stirred ball mill. Such grinding treatment leads often to a better access of water or acid to a particulate transition metal material.

Step (a) has often a duration in the range of from 10 minutes to 10 hours, preferably 1 to 3 hours. For example, the reaction mixture in step (a) is stirred at powers of at least 0.1 W/I or cycled by pumping in order to achieve a good mixing and to avoid settling of insoluble components. Shearing can be further improved by employing baffles. All these shearing devices need to be applied sufficiently corrosion resistant and may be produced from similar materials and coatings as described for the vessel itself.

Step (a) may be performed under an atmosphere of air or under air diluted with N₂. It is preferred, though, to perform step (a) under inert atmosphere, for example nitrogen or a rare gas such as Ar.

The treatment in accordance with step (a) leads in the leach usually to a dissolution of the transition metal containing material, for example of said NCM or NCA including impurities other than carbon and organic polymers. The leach may be obtained as a slurry after carrying out step (a). Lithium and transition metals such as, but not limited to cobalt, nickel and, if applicable, manganese, are often in dissolved form in the leach, e.g. in the form of their salts.

The copper impurities in the leach are present in dissolved form, e.g. as copper salts. The leach usually comprises a concentration of the copper impurities from 1 ppm to 10 000 ppm, preferably from 5 ppm to 1000 ppm, and in particular from 10 to 500 ppm.

Step (a) may be performed in the presence of a reducing agent. Examples of reducing agents are organic reducing agents such as methanol, ethanol, sugars, ascorbic acid, urea, bio-based materials containing starch or cellulose, and inorganic reducing agents such as hydrazine and its salts such as the sulfate, and hydrogen peroxide. Preferred reducing agents for step (a) are those that do not leave impurities based upon metals other than nickel, cobalt, or manganese. Preferred examples of reducing agents in step (a) are methanol and hydrogen peroxide. With the help of reducing agents, it is possible to, for example, reduce Co³⁺ to Co²⁺ or Mn(+IV) or Mn³⁺ to Mn²⁺. Preferably an excess of reducing agent is employed, referring to the amount of Co and—if present—Mn. Such excess is advantageous in case that Mn is present.

In embodiments wherein a so-called oxidizing acid has been used in step (a) it is preferred to add reducing agent in order to remove non-used oxidant. Examples of oxidizing acids are nitric acid and combinations of nitric acid with hydrochloric acid. In the context of the present invention, hydrochloric acid, sulfuric acid and methanesulfonic acid are preferred examples of non-oxidizing acids.

Depending on the concentration of the acid used, the leach obtained in step (a) may have a transition metal concentration in the range of from 1 up to 20% by weight, preferably 3 to 15% by weight.

### Between Steps (a) and (b)

Step (a) yields a leach which contains dissolved copper impurities. Optionally, the leach from step (a) can be treated by various methods before using it in step (b), such as by the steps (a1), (a2), and/or (a3). In a preferred form the steps (a1), (a2), and (a3) are carried out in the given order.

An optional step (a1) that may be carried out after step (a) and before step (b) is a removal of non-dissolved solids from the leach. The non-dissolved solids are usually carbonaceous materials, preferably carbon particles, and in particular graphite particles. The non-dissolved solids, such as the carbon particles, can be present in form of particles which have a particle size D50 in the range from 1 to 1000 μm, preferably from 5 to 500 μm, and in particular from 5 to 200 μm. The D50 may be determined by laser diffraction (ISO 13320 EN:2009-10). The step (a1) may be carried out by filtration, centrifugation, settling, or decanting. In step (a1) flocculants may be added. The removed non-dissolved solids can be washed, e.g. with water, and optinonally be further treated in order to separate the carbonaceous and polymeric components. Usually, step (a) and step (a1) are performed sequentially in a continuous operation mode.

A preferred form of step (a1) is removing of non-dissolved solids from the leach, where the non-dissolved solids are carbon particles (preferably graphite particles), and feeding the carbon particles into step (b) as deposition cathode. Thus the carbon particles from the battery scrap can be recycled and no new carbon particles need to be bought for the process.

Another optional step (a2) that may be carried out after step (a) or after step (a1) and before step (b) is adjusting the pH value of the leach to 2.5 to 8, preferably to 5.5 to 7.5 and in particular to 6 to 7. The pH value may be determined by conventional means, for example potentiometrically, and refers to the pH value of the continuous liquid phase at 20° C. The adjustment of the pH value is usually done by dilution with water or by addition of bases or by a combination thereof. Examples of suitable bases are ammonia and alkali metal hydroxides, for example LiOH, NaOH or KOH, in solid form, for example as pellets, or preferably as aqueous solutions. Combinations of at least two of the foregoing are feasible as well, for example combinations of ammonia and aqueous caustic soda. Step (a2) is preferably performed by the addition of at least one of sodium hydroxide, lithium hydroxide, ammonia and potassium hydroxide.

Another optional step (a3) that may be carried out after step (a2) and before step (b) is the removing of precipitates of phosphates, oxides, hydroxides or oxyhydroxides (e.g. of metals like Al, Fe, Sn, Si, Zr, Zn, or Cu or combinations thereof) by solid-liquid separation. Said precipitates may form during adjustment of the pH value in step (a2). Phosphates may be stoichiometric or basic phosphates. Without wishing to be bound by any theory, phosphates may be generated on the occasion of phosphate formation through hydrolysis of hexafluorophosphate. It is possible to remove the precipitates by solid-liquid separation such as filtration or with the help of a centrifuge or by sedimentation. Preferred filters are belt filters, filter press, suction filters, and cross-flow filter.

Preferably, the process comprises the steps (a2) adjusting the pH value of the leach to 2.5 to 8, and (a3) removing of precipitates of phosphates, oxides, hydroxides or oxyhydroxides.

### Step (b)

Step (b) comprises depositing the dissolved copper impurities as elemental copper on a particulate deposition cathode by electrolysis of an electrolyte containing the leach.

The electrolysis is usually made in an electrolytic cell by passing a direct electric current between an anode and a cathode through the electrolyte. The direct current (DC) is usually supplied by an electrical supply, which may provide the energy necessary to create or discharge ions in the electrolyte. The electrodes may provide the physical interface between the electrolyte and the electrical circuit that provides the energy. The electroylsis can be made once or repeatedly, for example in a sequential arrangment of electrolytic cells.

During electrolysis a electric charge of a specific amount of Coulombs may pass through the electrolyte. The amount of the charge depends on the size and type of the apparatus and can be determined by an expert. The electric current (also known as the charge per time) also depends on the size and type of the apparatus and can be determined by an expert.

During the electrolysis usually an electrochemical potential is applied to the deposition cathode. The electrochemical potential may be selected in such a way that copper is deposited on the deposition cathode. The electrochemical potential may further be selected in such a way that the deposition of less noble metals (e.g. Ni, Co and Mn) is excluded. The electrochemical potential may be controlled by a potentiostat or any other voltage generator with suitable accuracy. The electrochemical potential applied to the deposition cathode is usually kept in a range of −50 mV to −500 mV, preferably −100 mV to −400 mV, and in particular −150 mV to −300 mV with respect to the electrochemical potential of copper (Cu²⁺+2 e⁻→Cu⁰) in the electrolyte.

The electrolysis can be run potentiostatic or galvanostatic, wherin potentiostatic is preferred. The electrolysis is usually made at ambient temperature.

In another form step (b) comprises applying a further electrochemical potential to the deposition cathode during the electrolysis which allows the deposition of dissolved nickel salts as elemental nickel or dissolved cobalt salts as elemental cobalt on the deposition cathode. The further electrochemical potential is typically applied after the application of the electrochemical potential, which allows the deposition of the copper impurities. Before the electrochemical deposition of nickel and cobalt the depostition cathode may be exchanged by fresh material to avoid a contamination of nickel and cobalt by copper. The further electrochemical potential may be selected in such a way that the deposition of less noble metals is excluded. The further electrochemical potential applied to the deposition cathode is usually kept in a range of −50 mV to −500 mV, preferably −100 mV to −400 mV, and in particular −150 mV to −300 mV with respect to the electrochemical potential of nickel or of cobalt in the electrolyte.

The electrolyte is usually obtained from the step (a). Optionally, further steps may be in between step (a) and (b).

The electrolyte usually contains the leach. Typically, the electrolyte contains at least 50 wt %, preferably at least 80 wt %, and in particular at least 90 wt % of the leach. The electrolyte may contain the lithium or the transition metals in form of their salts (e.g. salts of Ni, Co, Mn) which are usually dissolved in the electrolyte. The electrolyte is usually an aqueous electrolyte, which may contain at least 60 wt %, preferably at least 80 wt %, and in particular at least 90 wt % water.

The total concentration of transition metals (e.g. Ni, Co, Mn) in the electrolyte may be at least 0.5 wt %, preferably at least 2 wt %, and at least 5 wt %. The concentration of the transition metals can be determined by elemental analysis.

The total concentration of lithium in the elektrolyte may be at least 0.1 wt %, preferably at least 0.5 wt %, and at least 1 wt %.

The total concentration of each indendently nickel, cobalt or mangan in the elektrolyte may be at least 0.1 wt %, preferably at least 1 wt %, and at least 2 wt %.

The electrolyte usually comprises before the electrolysis a concentration of the dissolved copper impurities from 1 ppm to 1000 ppm, preferably from 5 ppm to 300 ppm, and in particular from 10 to 100 ppm. In another form the electrolyte usually comprises before the electrolysis a concentration of the dissolved copper impurities from 1 ppm to 4000 ppm, preferably from 5 ppm to 2500 ppm, and in particular from 10 to 1000 ppm. In another form the electrolyte comprises before the electrolysis a concentration of the copper impurities up to 4000, 3000, 2500, 2000, 1500, 1000, 900, 800, 700, 600, 500, 400, 300, 200, or 100 ppm.

The copper impurities are deposited as elemental copper on the deposition cathode by the electrolysis. The electrolyte comprises after the electrolysis a concentration of the copper impurities up to 100, 80, 60, 40, 20, 10, 5, 3 or <1 ppm. Preferably, the electrolyte comprises after the electrolysis a concentration of the copper impurities up to 1 ppm.

The electrolyte is usually an aqueous electrolyte. The electrolyte may have a pH above 1, 2, 3, 4, or 5, preferably above 5. The electrolyte may have a pH below 10, 9, or 8. In another form the electrolyte may have a pH from 4 to 8. The electrolyte may contain buffer salts, e.g. salts of acetate, to adjust the pH value.

The particulate deposition cathode can be made of a electrically conductive material, such as metal, semiconductor, or carbon, or mixtures thereof. Preferably, the deposition cathode is made of copper or carbon. In one particular preferred form the deposition cathode is made of copper. In another particular preferred form the deposition cathode is made of carbon, such as graphite, carbon soot, coal, or charcoal. In another particular preferred form the deposition cathode is made of graphite, especially the carbon or graphite recovered from the battery material as described below.

The particulate deposition cathode may have a particle size D50 in the range from 1 to 1000 μm, preferably from 5 to 500 μm, and in particular from 5 to 200 μm. The d50 may be determined by laser diffraction according to ISO 13320 EN:2009-10.

The deposition cathode can be present in form of particles, preferably carbon particles, which have a conductivity in a range from 0.1-1000 S/cm, preferably from 1 to 500 S/cm.

The deposition cathode can be obtained at least partially from the transition metal material. Preferably, the deposition cathode is at least partially obtained prior to step (a) or in step (a1) by removing of non-dissolved solids from the leach, where the non-dissolved solids are carbon particles (preferably graphite particles), and feeding the carbon particles into step (b) as deposition cathode.

The anode can be present in any form, such as massive anode (e.g. as block, net, meshed metal baffle, foil, plate, or mixtures thereof). Suitable anode materials can me bade of anode materials which are dimensionally stable materials having low oxygen overvoltages. Examples for anode materials are titanium supports with electrically conducting interlayers of borides and/or carbides and/or silicides of subgroups IV to VI or tantalum and/or niobium, with or without platinum metal doping, the surface of which is doped with electrically conducting, non-stoichiometric mixed oxides of valve metals of subgroups IV to VI of the periodic table and metals or metal oxides of the platinum group or platinum metal compounds, eg. platinates.

Preference is given to using mixed oxides of tantalum-iridium, tantalum-platinum and tantalum-rhodium and also to platinates of the Li0.3 Pt3 O4 type. To enlarge the surface area the titanium supports may be surface-roughened or microporous.

The anode and the deposition cathode may be separated by a diaphragm or a cation exchange membrane. Suitable diaphragms are ceramic materials based on aluminum oxide and/or zirconium oxide or perfluorinated olefins which additionally contain ion-exchanging groups. The cation exchange membranes used are preferably polymers based on perfluorinated olefins or copolymers of tetrafluoroethylene with unsaturated perfluorinated ethers or copolymers of styrene and divinylbenzene which as charge-carrying groups contain sulfonic acid and carboxyl groups or only sulfonic acid groups. Preference is given to using membranes which contain sulfonic acid groups only, since they are significantly more stable to entrapment of and fouling by multivalent cations.

The particulate deposition cathode is usually the working electrode, in particular a cathodic working electrode. The term working electrode refers usually to the electrode in an electrochemical system on which the reaction of interest is occurring. The working electrode may be used in conjunction with an supporting electrode, in particular a supporting cathode.

In one preferred form step (b) comprises depositing the dissolved copper impurities as elemental copper on a particulate deposition cathode by electrolysis of an electrolyte containing the leach, where the particulate deposition cathode is suspended in the electrolyte.

The concentration of the suspended deposition cathode in the electrolyte may be from 0.01 to 10 wt %, preferably from 0.1 to 2 wt %, and in particular from 0.4 to 1.2 wt %.

Typically, an supporting cathode is used when the deposition cathode is suspended in the electrolyte. The supporting cathode can be present in any form, e.g. as block, net, meshed metal baffle, foil, plate, or mixtures thereof. The supporting cathode can be made of metal, semiconductor, or carbon, or mixtures thereof. Preferably, the supporting cathode is made of copper or carbon.

In another preferred form step (b) comprises depositing the dissolved copper impurities as elemental copper on a particulate deposition cathode by electrolysis of an electrolyte containing the leach, where the electrolyte is passed through the deposition cathode in form of a particulate filter-aid layer.

The deposition cathode in form of a particulate filter-aid layer may be more than 0.3 mm, preferably more than 0.5 mm deep. The filter-aid layer may be less than 10 mm, preferably less than 5 mm deep. The filter-aid layer may be renewed periodically (e.g. at intervals of from 2 to 180 minutes) by backwashing, classifying and precoating processes.

The filter-aid layer may be present on the supporting cathode, which is liquid permeable, such as fabrics or sinters, e.g. in the form of filter plates or plugs. The pore diameter of the filter fabric or sinter can range from 30 to 300 μm, preferably from 60 to 120 μm. The filter-aid layers can be polarized via the supporting electrode, which can be made of materials of low surface roughness which at a current density of 1 kA/m² have a hydrogen overvoltage of at least greater than or equal to 400 mV in order that the filter-aid layer may be polarized to the desired potential levels without hydrogen evolution. Suitable materials are for example silicon steels, stainless steel, copper, silver and graphite.

The electrolyte throughput through the filter-aid layer can range from 0.5 to 300 m³/m²h, preferably from 5 to 50 m³/m²h. A pressure loss may be from 0.2-3 bar, preferably from 0.4-1 bar. The current density for the cathodic polarization of the filter-aid layer can range from 0.1 to 10 kA/m², preferably from 0.5 to 3 kA/m².

In particular the electrolysis is made in an electrochemical filter flow cell in which the electrolyte is passed through a deposition cathode in form of a particulate filter-aid layer. The electrochemical filter flow cell comprises usually a flow cell anode, which can be made of anode materials as given above. The flow cell anode and the deposition cathode may be separated by a diaphragm or a cation exchange membrane as mentioned above.

The electrolysis may be made by an electrochemical filter flow cell in a batchwise or continuous process. In the case of the continuous process, the desired residual concentration of metal ions in the water is determined by the current supply, the process wastewater throughput and the number of electrolysis cells connected in series. To monitor the removal of metals it has been found to be advantageous to measure the potential of the filter-aid layer against a reference electrode. Suitable reference electrodes are for example thalamide, silver/silver chloride and calomel electrodes.

### After Step (b)

Optionally, the step (b) may be followed by further steps, such as step (c) and/or step (d).

The optional step (c) includes usually the precipitation of the transition metals as mixed hydroxides or mixed carbonates, preferably as mixed hydroxides. Step (c) includes preferably the precipitation of nickel and, optionally, cobalt or manganese as mixed hydroxide, mixed oxyhydroxide or mixed carbonate.

Step (c) is often performed by adding ammonia or an organic amine (such as dimethyl amine or diethyl amine), preferably ammonia, and at least one inorganic base such as lithium hydroxide, lithium bicarbonate, sodium hydroxide, potassium hydroxide, sodium carbonate, sodium bicarbonate, potassium carbonate or potassium bicarbonate or a combination of at least two of the foregoing. Preferred is the addition of ammonia and sodium hydroxide.

Step (c) is often performed at a temperature in the range of from 10 to 85° C., preferred are 20 to 50° C. The concentration of organic amine—or ammonia—is often in the range of from 0.01 to 1 mole/l, preferably 0.1 to 0.7 mole/l. The term “ammonia concentration” in this context includes the concentration of ammonia and ammonium. Particular preference is given to amounts of ammonia for which the solubility of Ni²⁺ and Co²⁺ in the mother liquor is not more than 1000 ppm each, more preferably not more than 500 ppm each.

Step (c) may be performed under air, under inert gas atmosphere, for example under noble gas or nitrogen atmosphere, or under reducing atmosphere. An example of a reducing gas is, for example, SO₂. Preference is given to working under inert gas atmosphere, especially under nitrogen gas. Step (c) may be performed in the presence or absence of one or more reducing agents. Examples of suitable reducing agents are hydrazine, primary alcohols such as, but not limited to methanol or ethanol, furthermore hydrogen peroxide, ascorbic acid, glucose and alkali metal sulfites. It is preferable not to use any reducing agent in step (c) when only minor amounts of Mn are present. The use of a reducing agent or inert atmosphere or both in combination is preferred in cases where significant amounts of manganese are present in the transition metal material, for example, at least 3 mol-%, referring to the transition metal part of the respective cathode active material.

Step (c) is often performed at a pH value in the range of from 7.5 to 12.5, preferred are pH values from 9 to 12 in the case of hydroxides and pH values in the range from 7.5 to 8.5 in the case of carbonates. The pH value refers to the pH value in the mother liquor, determined at 20° C. Step (c) may be carried out in a batch reactor or—preferably—continuously, for example in a continuous stirred tank reactor or in a cascade of two or more, for example two or three continuous stirred tank reactors.

As a result of step (c) usually a slurry containing transition metal (oxy)hydroxides as precipitates in a solution of alkali salts of the acids employed in the preceding steps optionally including the lithium contained in the transition metal material is obtained. For the purpose of further purify-cation, the solids recovered in step (c) may be dissolved in an acid, for example hydrochloric acid or more preferably sulfuric acid, and re-precipitated.

The slurry of transition metal (oxy)hydroxides or carbonates obtained in step (c) may be subjected to a solid-liquid separation process, preferably a filtration. The obtained mixed (oxy)hydroxide or mixed carbonate may be washed to reduce the amount of alkali entrained in the mixed (oxy)hydroxide or mixed carbonate to levels below 0.1% by weight, preferably below 0.01%. Then the obtained mixed hydroxides are re-dissolved in an appropriate acid, for example, hydrochloric acid or more preferably sulfuric acid. The re-dissolved mixed metal salts may be re-precipitated as mixed (oxy)hydroxide or mixed carbonate.

Typically, one or more and preferably all steps involving at least one of alkali metal hydroxides, alkali metal carbonates and alkali metal bicarbonates are performed with lithium hydroxide, lithium carbonate or lithium bicarbonate, respectively. In such embodiments, the lithium from the transition metal material, which will be dissolved during the process, is not contaminated with alkali metals other than lithium. The combined lithium containing solutions may be treated in a way to ensure high recovery of the lithium which to some extend can be re-introduced to the process while the rest can be used for the production of cathode active materials, for example by crystallization as lithium carbonate or by electrolysis or electrodialysis to yield lithium hydroxide.

In another form the process includes an additional step (d) of recovering the lithium by way of precipitation as carbonate or hydroxide, or by way of electrolysis or electrodialysis. Lithium carbonate may be crystallized by addition of ammonium, sodium or potassium carbonate. Although, as an alternative, lithium may be precipitated as phosphate or fluoride a lithium carbonate crystallization is preferred as lithium carbonate can be used in the manufacture of cathode active material directly or after transformation to lithium hydroxide.

### EXAMPLES

The metal impurities and phosphorous were determined by elemental analysis using ICP-OES (inductively coupled plasma—optical emission spectroscopy) or ICP-MS (inductively coupled plasma—mass spectrometry). Total carbon was determined with a thermal conductivity detector (CMD) after combustion. Fluorine was detected with an ion sensitive electrode (ISE) after combustion for total fluorine or after H₃PO₄ distillation for ionic fluoride.

### Example 1—Washing

Mechanically treated battery scrap (500 g; particle size D50 about 20 μm) was used comprising
203 g spent cathode active material with 1/1/1 molar ratio of Ni/Co/Mn, and a 1/1 molar ratio of Li to the sum of Ni, Co, and Mn as determined by elemental analysis;
199 g of total carbon in the form of graphite and soot and residual lithium containing electrolyte; and
41 g of further impurities comprising Al (10.7 g), Cu (4.9 g), F (in total: 9.8 g), Fe (1.1 g), P (2.5 g), Zn (0.14 g), Mg (100 mg), Ca (100 mg) as detemined by elemental analysis.

500 g of this battery scrap was slurried in 2 kg water and stirred vigorously for 30 minutes. Then the solids were separated by filtration and washed with 1 kg water. Solids were dried and then re-slurried in 400 g deionized water in a 2.5 L stirred batch reactor.

All impurity contents are given as weight percentages unless specifically noted otherwise, and refer to the total amount of mechanically treated battery scrap.

### Example 2—Leaching

A mixture of 841 g H₂SO₄ (50% H₂SO₄ in water) and 130 g hydrogen peroxide (30% H₂O₂ in water) was added dropwise to the slurry of Example 1 under vigorous stirring. The temperature of the slurry was kept between 30 and 40° C. After completion of the addition, the resulting reaction mixture was stirred for another 30 min at 30° C., heated to 40° C. for 20 minutes followed by heating to 60° C. for 40 minutes hours and then cooled to ambient temperature. Solids were removed from the resultant slurry by suction filtration. The filter cake was washed with 135 g deionized water. The combined filtrates (1644 g) contained 49 g Ni, 33 g Co, 30 g Mn, 4.9 g Cu and 14.6 g Li (as determined by elemental analysis), corresponding to leaching efficiencies >90% for all 5 metals. The dried filter cake (349 g) contained graphite particles which were used in Example 6 for electrolysis.

### Example 3—pH Adjustment

The pH value of 1350 g of the combined filtrates from Example 2 was adjusted to pH 6.0 by adding 495.5 g of a 4.5 molar caustic soda solution under stirring. Precipitate formation could be observed. After stirring for another 30 min the solids were removed by suction filtration. The obtained filtrate (2353 g) contains impurity levels of Al, Zn, Mg, Ca, and Fe below 25 ppm, and about 64 ppm of Cu.

### Comparative Example 4—Massive Carbon Cathode

An undivided electrochemical cell employing a solid glassy carbon anode and glassy carbon cathode (18 cm² geometric surface area each) and a Ag/AgCl reference electrode (KCl sat., 200 mV vs. NHE) was used and filled with 80 ml of electrolyte.

As electrolyte the filtrate obtained in Example 3 was used. Directly before its use following concentrations were analyzed: 9 ppm Al, 0.87% Co, traces of Cr, 64 ppm Cu, 1.2% Ni, and 0.1-1% inorganic fluoride. The solution had a pH of about 4-5. In order to avoid HF formation and therefore maintain a pH of >4 throughout the electrolysis, sodium acetate was added as buffer until the solution had a pH of 6.

Electrolysis was conducted potentiostatically in two steps at −50 mV vs. Ag/AgCl and −250 mV vs. Ag/AgCl. After having passed a charge of 14.7 Coulomb at a rate of 0.02 C/min the electrolysis was stopped. The mean rate of copper reduction was 1.1*10⁻⁷ mol/min.

The remaining solution was analyzed and the following composition was found: 9 ppm Al, 0.87% Co, traces of Cr, <1 ppm Cu and 1.3% Ni. Thus, Cu was selectively reduced.

### Comparative Example 5—Massive Copper Cathode

The same electrochemical cell as described in the previous Example 5 was used. Instead of a glassy carbon cathode, a copper cathode (18 cm² geometric surface area each) was employed.

As electrolyte the filtrate obtained in Example 3 was used. Directly before its use following concentrations were analyzed: 9 ppm Al, 0.85% Co, <1 ppm Cr, 60 ppm Cu, 1.2% Ni and 0.1-1% inorganic fluoride. The solution had a pH of about 4-5. Sodium acetate was added as buffer until the solution had a pH of 6.

Electrolysis was conducted potentiostatically at −250 mV vs. Ag/AgCl. After having passed a charge of 19.7 Coulomb at a rate of 0.02 C/min the electrolysis was stopped. The mean rate of copper reduction was 7.8*10⁻⁸ mol/min.

The remaining solution was analyzed and the following composition was found: 10 ppm Al, 0.90% Co, <1 ppm Cr, <1 ppm Cu and 1.3% Ni. Thus, Cu was selectively reduced.

### Example 6—Massive Carbon Cathode with Graphite Particles

The filter cake produced in Example 2 (Leaching) contained graphite particles and was dispersed in water and filtered repeatedly until no more changes in the metal impurities was detected. After drying the graphite particles contained about 5% fluorine, 1.7% Al, 0.06% Co, 0.01% Cu, 0.02% Fe, 0.04% Mn and 0.06% Ni after washing and total carbon content of 78.5 wt %. The resulting graphite particles had a particle size of D10=6 μm, D50=16 μm, and D90=83 μm.

An undivided electrochemical cell with glassy carbon anode (5 cm²) and glassy carbon cathode (18 cm²) as was used and filled with 80 ml of electrolyte. In addition, graphite particles were added to obtain a solid content of 0.68 wt.-% as graphite. In order to maintain periodical contact of the graphite particles with the cathode allowing charging of the particles, the electrolyte was stirred at 500 rpm using a magnetic stirrer bar. Thus, the graphite particles remain suspended in the electrolyte.

As electrolyte the filtrate obtained in Example 3 was used. Directly before its use following concentrations were analyzed: 10 ppm Al, 0.88% Co, <1 ppm Cr, 70 ppm Cu and 1.3% Ni, and 0.1-1% inorganic fluoride. The solution had a pH of about 4-5. Sodium acetate was added as buffer until the solution had a pH of 6.

Electrolysis was conducted potentiostatically in two steps at −75 mV vs. Ag/AgCl and −250 mV vs. Ag/AgCl. After having passed a charge of 19.2 C at a rate of 0.037 C/min the electrolysis was stopped. The mean rate of Cu reduction was 2.0*10⁻⁷ mol/min. The remaining solution was analyzed and the following composition was found: 10 ppm Al, 0.85% Co, <1 ppm Cr, <1 ppm Cu and 1.2% Ni. Thus, Cu was completely reduced.

As can be seen from the rate of which the current passed through the cell at constant potential, the residence time for complete Cu reduction could greatly be reduced by introducing the graphite particles into the cell. Making use of the graphite particles also reduces cost in a second way as no fresh graphite particles like graphite powder would need to be employed.

### Example 7—Filter Flow Cell with Graphite Particles

In another example an electrochemical filter flow cell following the principles described e.g. in U.S. Pat. No. 5,164,091 was used. Contrary to the cell described in U.S. Pat. No. 5,164,091, a horizontal orientation of the electrodes facing each other was chosen. The geometry of the whole electrochemical cell was cylindrical. Anode and cathode chamber were separated by a Nafion® 324 polymer electrolyte. As anode served an expanded Ti metal sheet coated with iridium and tantalum mixed oxides. The supporting electrolyte in the anode chamber was a saturated potassium sulfate solution.

A stainless steel mesh (20 cm², 1.4571) served as conductive support to build up the filter cake of the graphite particles, which were isolated from the filter cake produced in Example 2 (Leaching) as described in Example 6. Prior to starting the electrolysis, about 3 g of that graphite particles were filtered onto the stainless steel support mesh forming a layer of about 5 mm thickness.

As electrolyte 80 ml of the filtrate obtained in Example 3 was used. Directly before its use following concentrations were analyzed: 0.7% Co, <1 ppm Cr, 37 ppm Cu, 0.96% Ni and 0.1-1% inorganic fluoride. The electrolyte was introduced to the cathode chamber with a backpressure of about 50 to 100 mbar. The solution had a pH of about 4-5. Sodium acetate was added as buffer until the solution had a pH of 6.

Electrolysis was conducted at −250 mV vs. Ag/AgCl. After having passed a charge of 10.9 C at a rate of 0.36 C/min the electrolysis was stopped. The mean rate of copper reduction was 1.5*10⁻⁶ mol/min. The electrolyzed solution was analyzed and the following composition was found: 0.7% Co, <1 ppm Cr, <1 ppm Cu and 0.96% Ni. Thus, Cu was completely reduced.

As can be seen from the rate of which the current passed through the cell at constant potential, the residence time for complete Cu reduction was greatly reduced by a factor of ten compared to the undivided electrochemical cell with suspended graphite particles mentioned above.

1-17. (canceled)

18. A process for the recovery of transition metals from batteries comprising
(a) treating a transition metal material from batteries with a leaching agent to yield a leach, wherein the leach comprises dissolved copper impurities, and
(b) depositing the dissolved copper impurities as elemental copper on a particulate deposition cathode by electrolysis of an electrolyte comprising the leach.

19. The process according to claim 18, wherein the deposition cathode has a particle size d50 ranging from 1 μm to 1000 μm.

20. The process according to claim 18, wherein the electrolyte comprises less than or equal to 4000 ppm of the copper impurities before the electrolysis.

21. The process according to claim 18, wherein the deposition cathode is made of copper and/or carbon.

22. The process according to claim 18, wherein an electrochemical potential is applied to the deposition cathode during the electrolysis ranging from −50 mV to −500 mV with respect to the electrochemical potential of copper.

23. The process according to claim 18, wherein the electrolyte has a pH from 4 to 8.

24. The process according to claim 18, wherein the transition metal material is obtained from mechanically treated battery scraps, or is obtained as metal alloy from smelting battery scrap.

25. The process according to claim 18, wherein the deposition cathode is obtained at least partially from the transition metal material.

26. The process according to claim 18, further comprising removing non-dissolved solids from the leach, wherein the non-dissolved solids are carbon particles, and feeding the carbon particles into step (b) as deposition cathode.

27. The process according to claim 18, further comprising precipitating the transition metal as mixed hydroxides or mixed carbonates.

28. The process according to any of claims 18, wherein the leaching agent is an inorganic or organic aqueous acid.

29. The process according to claim 18, further comprising adjusting the pH value of the leach to 2.5 to 8, and removing precipitates of phosphates, oxides, hydroxides, and/or oxyhydroxides by solid-liquid separation.

30. The process according to claim 18, wherein the deposition cathode is suspended in the electrolyte.

31. The process according to claim 30 wherein the concentration of the suspended deposition cathode in the electrolyte is from 0.01 wt % to 10 wt %.

32. The process according to claim 18, wherein the electrolyte is passed through the deposition cathode as a particulate filter-aid layer.

33. The process according to claim 32, wherein the electrolysis is performed in an electrochemical filter flow cell.

34. The process according to claim 18, wherein step (b) comprises applying a further electrochemical potential to the deposition cathode during the electrolysis and depositing dissolved nickel salts as elemental nickel on the particulate electrode and/or depositing dissolved cobalt salts as elemental cobalt on the particulate electrode.
